(19) United States
(12) Patent Application Publication
(10) Pub. No.: US 2013/0016288 A1
(43) Pub. Date: Jan. 17, 2013

(54) TELEVISION SYSTEM, PEDESTAL, AND ELECTRONIC APPARATUS

(71) Applicant: Takashi Asano, Fukaya-shi (JP)

(72) Inventor: Takashi Asano, Fukaya-shi (JP)

(21) Appl. No.: 13/418,015

(22) Filed: Mar. 12, 2012

(30) Foreign Application Priority Data
Jul. 11, 2011 (JP) 2011-153220

(51) Int. Cl. H04N 5/64

(52) U.S. Cl. 348/836; 348/E05.128

(57) ABSTRACT

According to one embodiment, an electronic apparatus includes a display unit, a base, a fixing portion, and an angle adjuster. The display unit includes a display surface which displays an image and a housing which encloses the display surface. The base is placed on a mounting surface such that the base faces a bottom portion of the housing. The fixing portion is disposed on the base and configured to secure the display unit. The angle adjuster is disposed on the base and/or the bottom portion of the housing and interposed between the base and the bottom portion so that the display unit is inclined.

### CROSS-REFERENCE TO RELATED APPLICATIONS

This application is based upon and claims the benefit of priority from prior Japanese Patent Application No. 2011-153220, filed Jul. 11, 2011, the entire contents of which are incorporated herein by reference.

### FIELD

Embodiments described herein relate generally to a television system, a pedestal, and an electronic apparatus.

### BACKGROUND

A flat-screen television generally comprises a pedestal for supporting a display unit that displays images. The pedestal comprises, for example, a base placed on a mounting surface of a television stand, and a pillar projecting upward from the base and secured to the display unit. In some pedestals of this type, a cover is mounted on the base, the pillar is designed to be rotatable, or a hinge is provided such that the display unit is inclinable.

The pedestal may sometimes have diverse functions other than supporting the display unit. In this case, the structure of the pedestal may be complicated.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing a television system according to a first embodiment;

FIG. 2 is an exemplary rear view of the television system of the first embodiment with its pedestal separated from its display unit;

FIG. 3 is an exemplary bottom plan view of the display unit of the first embodiment;

FIG. 4 is an exemplary sectional view schematically showing a part of the television system of the first embodiment;

FIG. 5 is an exemplary perspective view showing a part of a rear cover of the first embodiment taken from inside a housing;

FIG. 6 is an exemplary perspective view showing the pedestal of the first embodiment;

FIG. 7 is an exemplary rear view showing the pedestal connected to a mounting surface of the first embodiment;

FIG. 8 is an exemplary sectional view schematically showing a method for attaching the pedestal to the display unit of the first embodiment;

FIG. 9 is an exemplary perspective view showing a pedestal according to a second embodiment;

FIG. 10 is an exemplary perspective view showing a pedestal according to a third embodiment; and

FIG. 11 is an exemplary perspective view showing a part of a television system according to a fourth embodiment.

### DETAILED DESCRIPTION

Various embodiments will be described hereinafter with reference to the accompanying drawings.

In general, according to one embodiment, an electronic apparatus includes a display unit, a base, a fixing portion, and an angle adjuster. The display unit includes a display surface which displays an image and a housing which encloses the display surface. The base is placed on a mounting surface such that the base faces a bottom portion of the housing. The fixing portion is disposed on the base and configured to secure the display unit. The angle adjuster is disposed on the base and/or the bottom portion of the housing and interposed between the base and the bottom portion so that the display unit is inclined.

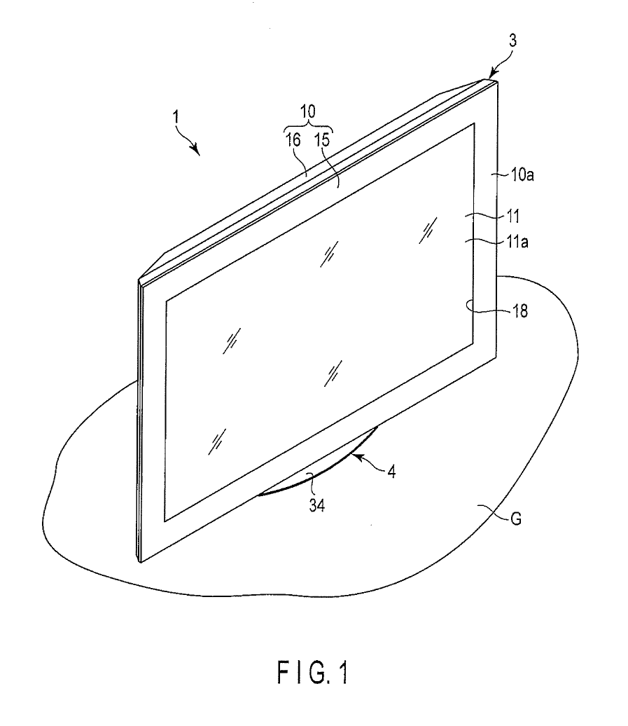

A first embodiment will now be described with reference to FIGS. 1 to 8. In this specification, the user side is defined as forward; the far side from the user as rearward, the user's left-hand side as leftward, the user's right-hand side as rightward, the upper side with respect to the user as upward, and the lower side with respect to the user as downward.

FIG. 1 is a perspective view showing a television system 1 according to the first embodiment. The television system 1 is an example of a television system and an electronic apparatus, such as a liquid-crystal television. The television system 1 is not limited to the liquid-crystal television, and may alternatively be a television of another type, such as a plasma television, or another electronic apparatus, such as an organic electroluminescent display of a personal computer.

As shown in FIG. 1, the television system 1 comprises a display unit 3 and pedestal 4. The pedestal 4 is removably attached to the display unit 3. The pedestal 4 is placed on, for example, a mounting surface G of a television stand and supports the display unit 3.

The display unit 3 comprises a housing 10 and liquid-crystal display 11.

The housing 10, e.g., a plastic structure, comprises a front cover 15 and rear cover 16. The front cover 15 comprises a front portion 10a of the housing 10 that faces a user. The front cover 15 is a frame structure, and an opening 18 is formed in the front portion 10a. The front cover 15 is secured to the rear cover 16 by, for example, screws.

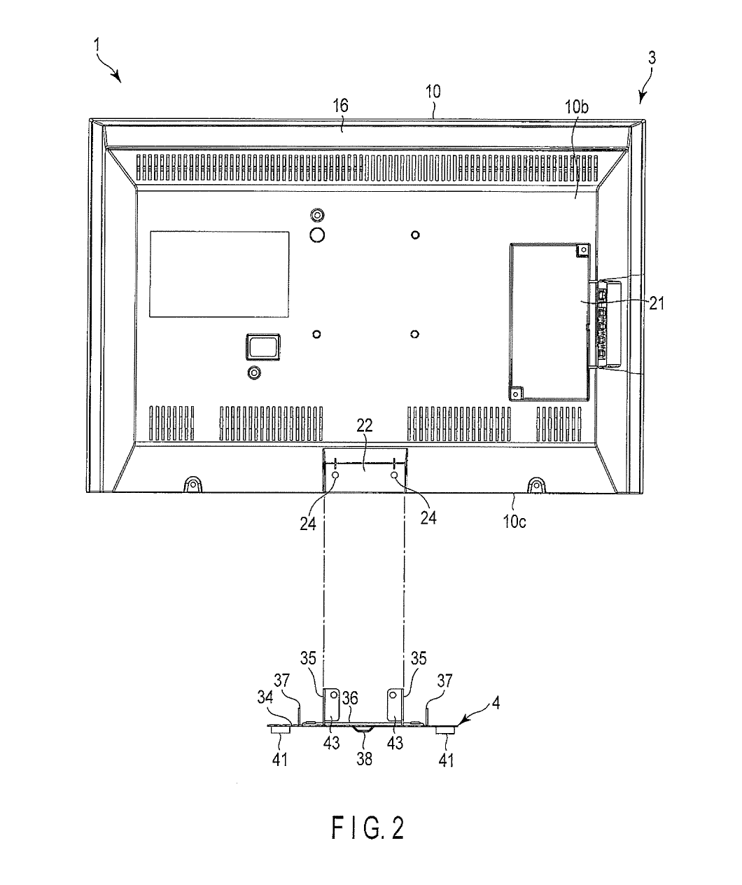

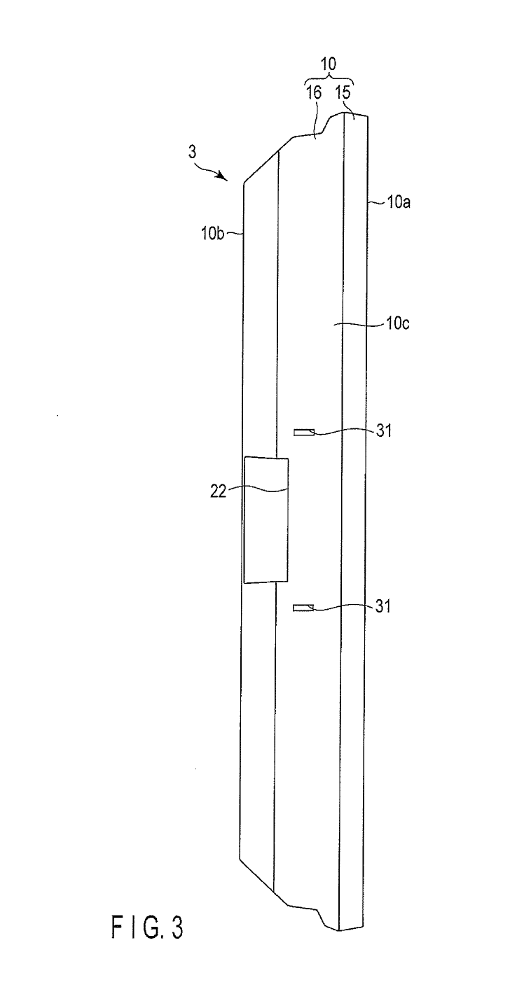

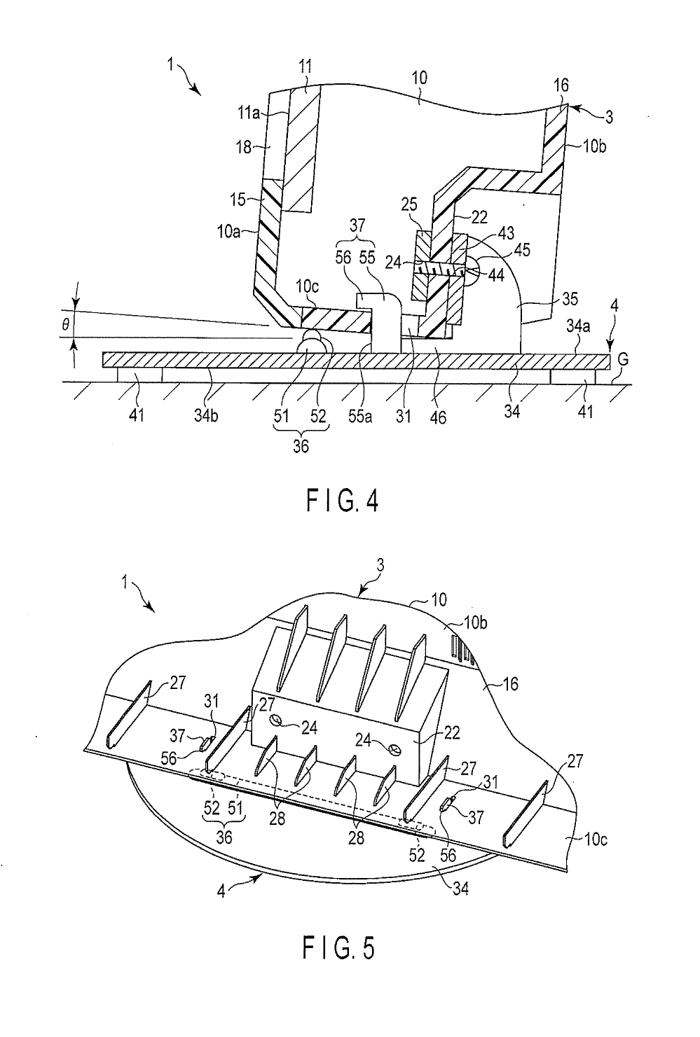

FIG. 2 is a rear view of the television system 1 with its pedestal 4 separated from the display unit 3. FIG. 3 is a bottom plan view of the display unit 3. FIG. 4 is a sectional view schematically showing a part of the television system 1.

As shown in FIG. 4, the rear cover 16 comprises a rear portion 10b and bottom portion 10c of the housing 10. As shown in FIG. 2, a terminal area 21 and mounting portion 22 are disposed on the rear portion 10b of the housing 10. A plurality of terminals are arranged on the terminal area 21.

The terminal area 21 is a depression recessed from a flat surface of the rear portion 10b. The terminal area 21 carries thereon a plurality of terminals, such as tuner, video input, and voice input/output terminals.

The mounting portion 22 is located adjacent to the bottom portion 10c of the housing 10. The mounting portion 22 is a flat region recessed from the rear portion 10b. Two fixing holes 24 open in the mounting portion 22. As shown in FIG. 4, a metallic reinforcement plate 25 that contacts the mounting portion 22 is disposed within the housing 10. The fixing holes 24 are bored through the mounting portion 22 and reinforcement plate 25.

FIG. 5 is a perspective view showing a part of the rear cover 16 taken from inside the housing 10. As shown in FIG. 5, a plurality of first ribs 27 and second ribs 28 are disposed within the housing 10.

The first and second ribs 27 and 28 individually extend from the bottom portion 10c of the housing 10 toward inside of the housing 10. The first ribs 27 are located ranging from the bottom portion 10c of the housing 10 to the rear portion 10b. The second ribs 28 are located ranging from the bottom portion 10c of the housing 10 to the mounting portion 22.

A slit configured to engage a protrusion on the front cover 15 is formed in an end portion of each of the first ribs 27. The first ribs 27 project higher than the second ribs 28. Thus, those parts of the bottom portion 10c which carry the first ribs 27 are stronger than those parts for the second ribs 28.

As shown in FIG. 4, the bottom portion 10c of the housing 10 is in the form of a flat plate wall. As shown in FIG. 3, a pair of receiving holes 31 are formed in the bottom portion 10c of the housing 10. Each receiving hole 31 has a rectangular shape extending from the front portion 10a of the housing 10 toward the rear portion 10b.

As shown in FIG. 4, the liquid-crystal display 11 is accommodated in the housing 10. The display 11 has a display surface 11a exposed from the opening 18 of the housing 10. The display surface 11a is enclosed by the frame-like front cover 15.

The liquid-crystal display 11 displays images on the display surface 11a under the control of a control board in the housing 10. In the present embodiment, the images include moving images, still images, and monochrome images.

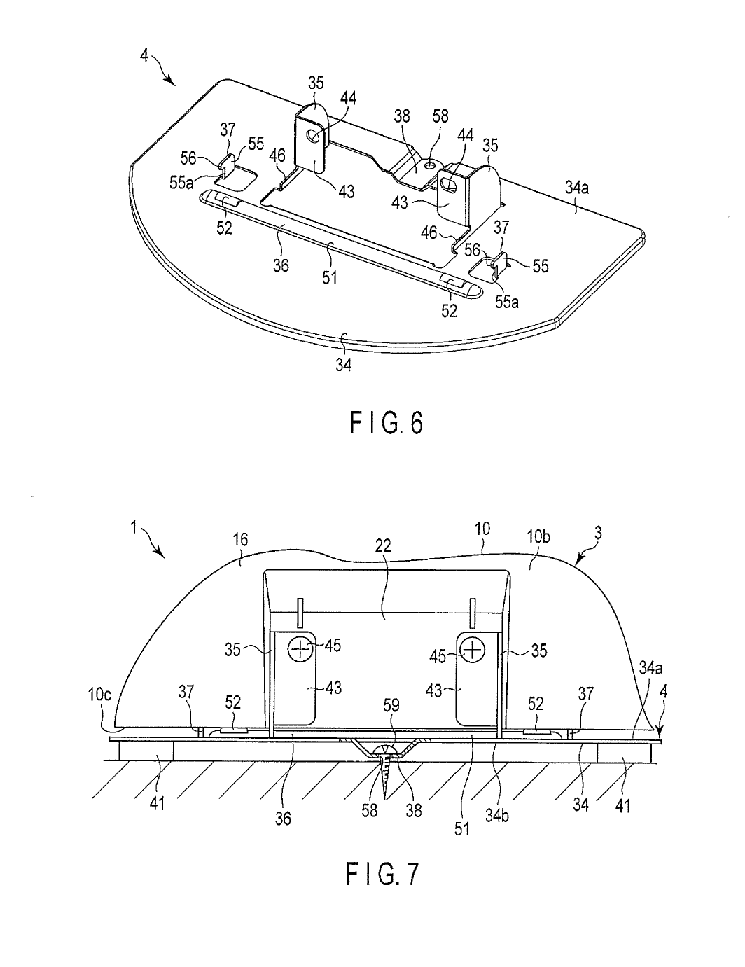

FIG. 6 is a perspective view showing the pedestal 4. As shown in FIG. 6, the pedestal 4 comprises a base 34, a pair of fixing portions 35, angle adjuster 36, a pair of engaging portions 37, and an anti-topple portion 38.

The pedestal 4 is formed by, for example, bending a single metal plate. Thus, the base 34, fixing portions 35, angle adjuster 36, engaging portions 37, and anti-topple portion 38 are integrally formed together.

As shown in FIG. 4, the base 34 is a flat structure having upper and lower surfaces 34a and 34b. The upper surface 34a faces the bottom portion 10c of the housing 10. A plurality of rubber feet 41 are mounted on the lower surface 34b, which faces the mounting surface G. The base 34 is placed on the mounting surface G with the aid of the rubber feet 41. Alternatively, the base 34 may be placed directly on the mounting surface G without the aid of the rubber feet 41. Further, the peripheral edge of the base 34 may be bended for higher rigidity.

As shown in FIG. 6, the fixing portions 35 are individually set up on the upper surface 34a of the base 34. The fixing portions 35 are bent at right angles to the width of the display unit 3 from the base 34. As shown in FIG. 2, the fixing portions 35 are located corresponding to the mounting portion 22.

Each fixing portion 35 comprises a receiving portion 43 that faces the mounting portion 22. The receiving portions 43 are formed by being bent along the mounting portion 22. As shown in FIG. 4, the receiving portions 43 are slightly inclined backward. The mounting portion 22 contacts the receiving portions 43.

The receiving portions 43 are provided individually with through-holes 44 corresponding to the fixing holes 24 of the mounting portion 22. Fixing members 45, such as screws, are driven into the fixing holes 24 of the mounting portion 22 through the through-holes 44, individually. In this way, the display unit 3 is secured to the fixing portions 35.

A rib-like reinforcement portion 46 is formed integrally with each fixing portion 35. The reinforcement portions 46 extend from their corresponding fixing portions 35 toward the front portion 10a of the housing 10. The bottom portion 10c of the housing 10 contacts the reinforcement portions 46. Alternatively, the bottom portion 10c of the housing 10 may be configured to contact the upper surface 34a of the base 34 in place of the reinforcement portions 46.

As shown in FIG. 6, the angle adjuster 36 is disposed on the upper surface 34a of the base 34. As shown in FIG. 4, the angle adjuster 36 is located corresponding to the front side of the bottom portion 10c of the housing 10. In other words, the angle adjuster 36 is located closer to the front portion 10a of the housing 10 than to the rear portion 10b.

The angle adjuster 36 is formed integrally with the base 34 by, for example, press working. It comprises an extending portion 51 and a pair of contact portions 52.

The extending portion 51 projects upward on the side of the display unit 3 from the upper surface 34a of the base 34. The extending portion 51 has an arcuate cross-section. As indicated by broken line in FIG. 5, the extending portion 51 extends longitudinally along the bottom portion 10c of the housing 10.

As shown in FIG. 6, the contact portions 52 are located individually at the opposite end portions of the extending portion 51. The contact portions 52 project upward on the side of the display unit 3 from the extending portion 51. Each contact portion 52 has an arcuate cross-section. As shown in FIG. 4, the top of each contact portion 52 is located higher than the reinforcement portion 46 formed integrally with each corresponding fixing portion 35.

The contact portions 52 contact the bottom portion 10c in a position closer to the front portion 10a of the housing 10 than to the rear portion 10b. The bottom portion 10c of the housing 10 is in contact with the contact portions 52 of the angle adjuster 36 and the reinforcement portions 46 of the fixing portions 35. Thus, the display unit 3 is inclined backward at an angle θ to the base 34. In other words, the angle adjuster 36 is interposed between the base 34 and the bottom portion 10c of the housing 10 and supports the display unit 3 inclined at the angle O.

As shown in FIG. 5, the contact portions 52 are located corresponding to positions where of the first ribs 27 are arranged in the housing 10. Thus, the contact portions 52 contact the bottom portion 10c of the housing 10 in positions corresponding to the first ribs 27.

As shown in FIG. 6, the engaging portions 37 project upward on the side of the display unit 3 from the upper surface 34a of the base 34. The engaging portions 37 are located forward or closer to the front portion 10a of the housing 10 than to the fixing portions 35. The engaging portions 37 are located corresponding individually to the receiving holes 31 in the bottom portion 10c of the housing 10. As shown in FIG. 4, the engaging portions 37 are inserted into the receiving holes 31, individually.

Each engaging portion 37 comprises a rising portion 55 and pawl portion 56. The rising portion 55, which projects from the base 34, comprises a front edge 55a that faces forward away from the fixing portion 35. The front edge 55a contacts the inner edge of its corresponding receiving hole 31

The pawl portion 56 projects from the front edge 55a at the distal end portion of the rising portion 55. The pawl portion 56 is in the housing 10 and internally hooked on the bottom portion 10c of the housing 10.

The anti-topple portion 38, which is disposed at the rear end of the base 34, as shown in FIG. 6, is bent so that it is recessed from the upper surface 34a of the base 34. The anti-topple portion 38 is located closer to the mounting surface G than to the base 34. A mounting hole 58 is formed in the anti-topple portion 38.

FIG. 7 is a cutaway rear view of the pedestal 4 connected to the mounting surface G. As shown in FIG. 7, an anti-topple member 59 is attached to the anti-topple portion 38. The anti-topple member 59 is, for example, a wood screw. The anti-topple member 59 is driven into the mounting surface G through the mounting hole 58 of the anti-topple portion 38. Thus, the anti-topple portion 38 is connected to the mounting surface G. The anti-topple member 59 is not limited to the wood screw and may alternatively be a belt or a clip through which wire can be passed.

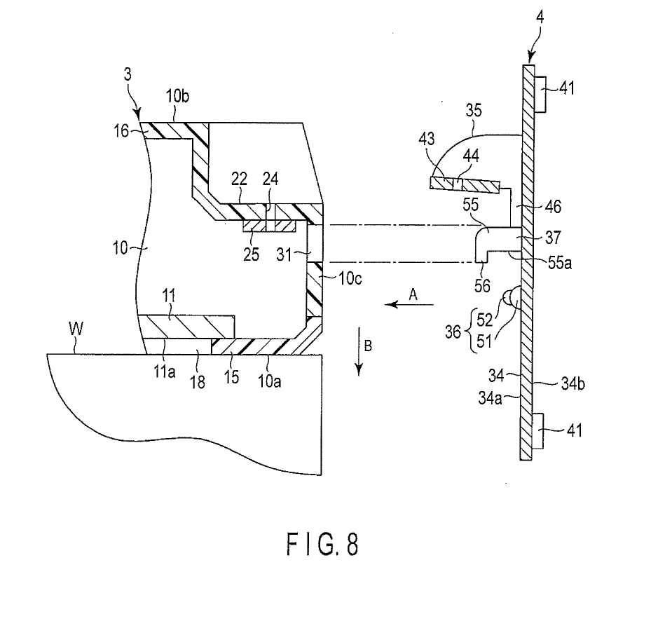

FIG. 8 is a sectional view schematically showing a method for attaching the pedestal 4 to the display unit 3. For example, the pedestal 4 is attached to the display unit 3 in the following manner. As shown in FIG. 8, the display unit 3 is first placed on a working surface W of, for example, a desk such that the front portion 10a of the housing 10 contacts the working surface W. In other words, the display unit 3 is placed on the working surface W so that the front portion 10a of the housing 10 faces downward.

Then, the engaging portions 37 of the pedestal 4 are inserted individually into the receiving holes 31 in the bottom portion 10c of the housing 10, as indicated by arrow A in FIG. 8. When the engaging portions 37 are inserted into the receiving holes 31, the reinforcement portions 46 of the fixing portion 35 and the contact portions 52 of the angle adjuster 36 contact the bottom portion 10c of the housing 10.

Subsequently, the pedestal 4 is slid down from the rear portion 10b of the housing 10 toward the front portion 10a, as indicated by arrow B in FIG. 8. Thereupon, the respective front edges 55a of the rising portions 55 of the engaging portions 37 contact the respective inner edges of the receiving holes 31, individually. The pawl portions 56 are internally hooked on the bottom portion 10c of the housing 10. Further, the respective receiving portions 43 of the fixing portions 35 contact the mounting portion 22 of the housing 10.

The engaging portions 37 are supported by the inner edges of the receiving holes 31. Further, the receiving portions 43 of the fixing portions 35 are supported by the mounting portion 22 of the housing 10. In this state, the through-holes 44 in the fixing portions 35 are located corresponding individually to the fixing holes 24 of the mounting portion 22. Thus, the pedestal 4 can be held in a fixed position without tacking or the like. Since the pawl portions 56 are anchored to the bottom portion 10c of the housing 10, the pedestal 4 can be prevented from detaching from the display unit 3 even if it is pushed away from the display unit 3.

Then, the fixing members 45 are driven individually into the fixing holes 24 in the mounting portion 22 through the through-holes 44 of the fixing portion 35. The fixing portions 35 are connected to the mounting portion 22 by the fixing members 45. The pedestal 4 is attached to the display unit 3 by the processes described above.

Alternatively, the display unit 3 may be attached to the pedestal 4, which is placed on the working surface W, from above. In this case, if the engaging portions 37 of the pedestal 4 are inserted into the receiving holes 31 of the housing 10, the angle adjuster 36 and reinforcement portions 46 contact the bottom portion 10c of the housing 10 and support the display unit 3.

The display unit 3 is inclined at the angle e by the angle adjuster 36. Since the pawl portions 56 of the engaging portions 37 are internally hooked on the bottom portion 10c of the housing 10, however, the display unit 3 can be prevented from falling over without tacking or the like.

According to the television system 1 constructed in this manner, the display unit 3 is inclined at the angle θ by the angle adjuster 36 of the pedestal 4 interposed between the base 34 and the bottom portion 10c of the housing 10. Accordingly, the display unit 3 is inclined relative to the pedestal 4 to improve the user's view of the display surface 11a without the use of a mechanism such as a hinge. Thus, the television system 1 is simplified in structure, improved in productivity, and reduced in manufacturing cost.

The angle adjuster 36 projects from the base 34 of the metallic pedestal 4. Therefore, the bottom portion 10c of the housing 10 of the display unit 3 is formed flat. Further, the angle adjuster 36 is prevented from being deformed by the weight of the display unit 3.

The base 34, fixing portions 35, angle adjuster 36, engaging portions 37, and anti-topple portion 38 of the pedestal 4 are integrally formed by, for example, bending a single metal plate. Thus, the manufacturing cost of the pedestal 4 can be reduced.

The angle adjuster 36, which is formed projecting from the base 34 by, for example, press working, and the reinforcement portions 46, which are formed like ribs by bending, contact the bottom portion 10c of the housing 10 and support the display unit 3. Thus, the flat base 34 is prevented from being deformed by the weight of the display unit 3.

The contact portions 52 of the angle adjuster 36 contact the bottom portion 10c of the housing 10 in positions corresponding individually to the first ribs 27. Those parts of the bottom portion 10c which carry the first ribs 27 thereon are stronger than those parts for the second ribs 28 and the ribless part. Thus, those parts of the bottom portion 10c which are in contact with the contact portions 52 are prevented from being deformed. Alternatively, the contact portions 52 may be configured to contact the bottom portion 10c of the housing 10 in positions corresponding individually to the second ribs 28.

The pedestal 4 comprises the engaging portions 37, which are inserted into the receiving holes 31 in the bottom portion 10c of the housing 10. As the pedestal 4 is attached to the display unit 3, therefore, it is prevented from detaching from the display unit 3, or the display unit 3 from falling over. Further, the engaging portions 37 on the metallic pedestal 4 are prevented from being broken by a moment produced by the inclination of the display unit 3. Since the receiving holes 31 into which the engaging portions 37 are inserted are formed in the bottom portion 10c of the housing 10, moreover, a part for mounting, such as the mounting portion 22, is made small.

The extending portion 51 of the angle adjuster 36 extends longitudinally along the bottom portion 10c of the housing 10. A gap is formed between the base 34 and the bottom portion 10c of the housing 10 by the angle adjuster 36. This gap is closed by the extending portion 51. In other words, the extending portion 51 prevents the user from viewing, for example, the fixing portions 35 through the gap. Thus, the external appearance of the television system 1 is improved.

The anti-topple portion 38 is disposed on the base 34 of the pedestal 4. It is connected to the mounting surface G by the anti-topple member 59. Thus, the television system 1 is prevented from being toppled by, for example, an earthquake.

The anti-topple portion 38 is located closer to the mounting surface G than to the base 34. When it is connected to the mounting surface G by the anti-topple member 59, therefore, the anti-topple portion 38 is prevented from being deformed by the fastening force of the anti-topple member 59, or the front part of the base 34 from being lifted.

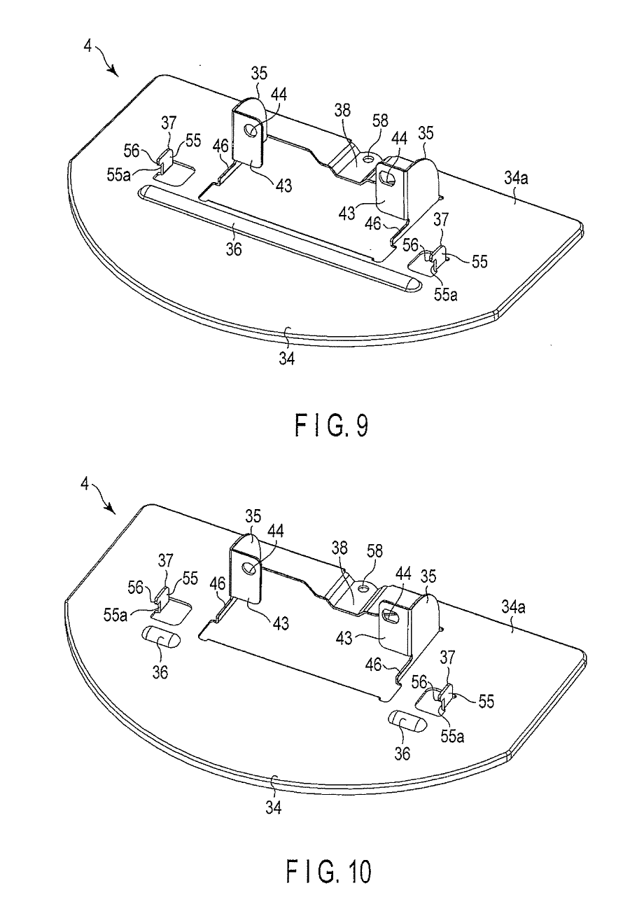

A second embodiment will now be described with reference to FIG. 9. In the description of a plurality of embodiments to follow, like reference numbers are used to designate like constituent elements having the same functions as those of the television system 1 of the first embodiment. A description of some or all of those constituent elements may be omitted.

FIG. 9 is a perspective view showing a pedestal 4 according to the second embodiment. As shown in FIG. 9, an angle adjuster 36 of the second embodiment extends longitudinally along a bottom portion 10c of a housing 10. The angle adjuster 36 has an arcuate cross-section. The top of the angle adjuster 36 is located higher than reinforcement portions 46 that are formed integrally with fixing portions 35.

The angle adjuster 36 is in linear contact with the flat bottom portion 10c of the housing 10. The area of contact between the angle adjuster 36 and the bottom portion 10c of the housing 10 of the second embodiment is larger than that between the contact portions 52 and the bottom portion 10c of the housing 10 of the first embodiment. Thus, stress concentration on the bottom portion 10c of the housing 10 is suppressed.

The angle adjuster 36 extends longitudinally along the bottom portion 10c of the housing 10. In the region where the angle adjuster 36 extends, a gap between the bottom portion 10c of the housing 10 and base 34 is closed by the angle adjuster 36. Thus, the external appearance of a television system 1 is improved.

A third embodiment will now be described with reference to FIG. 10. FIG. 10 is a perspective view showing a pedestal 4 of the third embodiment. As shown in FIG. 10, the pedestal 4 of the third embodiment comprises a pair of angle adjusters 36. Each angle adjuster 36 has an arcuate cross-section. The top of each angle adjuster 36 is located higher than reinforcement portions 46 that are formed integrally with fixing portions 35.

The angle adjusters 36 individually contact a flat bottom portion 10c of a housing 10 in positions corresponding individually to the first ribs 27. Thus, those parts of the bottom portion 10c of the housing 10 which are in contact with the angle adjusters 36 are prevented from being deformed.

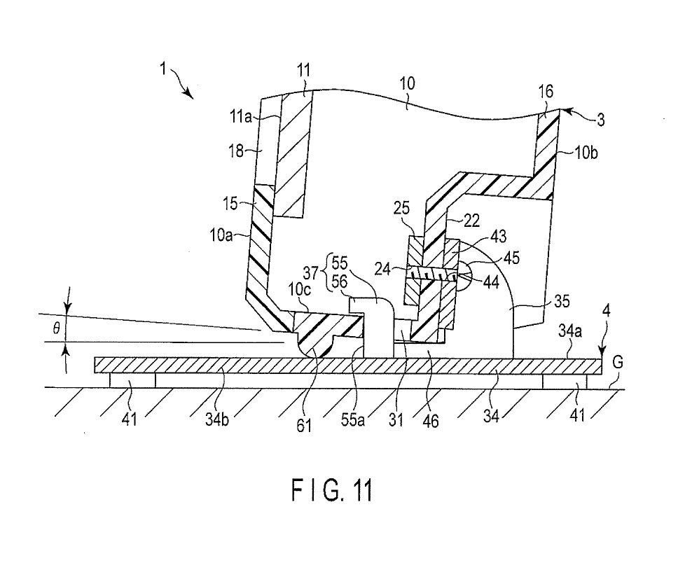

A fourth embodiment will now be described with reference to FIG. 11. FIG. 11 is a sectional view showing a part of a television system 1 according to the fourth embodiment. In the television system 1 of the fourth embodiment, as shown in FIG. 11, a display unit 3 comprises a pair of angle adjusters 61 in place of angle adjusters on a pedestal 4.

The angle adjusters 61 are disposed on a bottom portion 10c of a housing 10 in positions corresponding individually to the first ribs 27. The angle adjusters 61 project downward on the side of a base 34 of the pedestal 4 from the bottom portion 10c of the housing 10. Each angle adjuster 61, which is integral with the housing 10, has an arcuate cross-section. The angle adjusters 61 are located closer to a front portion 10a of the housing 10 than to a rear portion 10b.

The angle adjusters 61 contact an upper surface 34a of the base 34. The bottom portion 10c of the housing 10 contacts reinforcement portions 46 of fixing portions 35. The height of the top of each angle adjuster 61 above the bottom portion 10c of the housing 10 is greater than that of the top of each reinforcement portion 46 above the upper surface of the base 34. Thus, the display unit 3 is inclined backward at the angle θ to the base 34. In other words, the angle adjuster 36 is interposed between the base 34 and the bottom portion 10c of the housing 10 and supports the display unit 3 inclined at the angle θ.

According to the television system 1 constructed in this manner, the angle adjusters 61 of the display unit 3 are interposed between the base 34 and the bottom portion 10c of the housing 10 so that the display unit 3 is inclined at the angle θ. Thus, the television system 1 is simplified in structure, improved in productivity, and reduced in manufacturing cost. Specifically, the angle adjusters may be disposed on the bottom portion 10c of the housing 10 of the display unit 3 in place of the base 34 of the pedestal 4. Further, the angle adjusters may be disposed on either of the base 34 of the pedestal 4 and the bottom portion 10c of the housing 10 of the display unit 3.

According to the television system of at least one of the embodiments described above, the angle adjuster or adjusters are interposed between the base and the bottom portion of the housing so that the display unit is inclined. Thus, the structure of the television system is simplified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the fixing portions 35 of the pedestal 4 are secured to the mounting portion 22 of the display unit 3 according to each of the embodiments described herein. Alternatively, however, the fixing portions may be secured to some other portion, such as the bottom portion 10c of the housing 10.

What is claimed is:

1. A television system comprising:
a display unit comprising a display surface which displays an image and a housing which encloses the display surface;
a base placed on a mounting surface such that the base faces a bottom portion of the housing;
a fixing portion disposed on the base and configured to secure the display unit; and
an angle adjuster disposed on the base and/or the bottom portion of the housing and interposed between the base and the bottom portion so that the display unit is inclined.

2. The television system of claim 1, wherein the angle adjuster projects from the base toward the display unit and supports the display unit in an inclined state by contacting the bottom portion of the housing.

3. The television system of claim 2, wherein the base, the fixing portion, and the angle adjuster are formed integrally with one another.

4. The television system of claim 3, wherein the display unit comprises a rib extending from the bottom portion of the housing toward inside of the housing, and the angle adjuster contacts the bottom portion of the housing in a position corresponding to the rib.

5. The television system of claim 4, further comprising an engaging portion projecting integrally from the base, wherein the bottom portion of the housing is formed with a receiving hole into which the engaging portion is inserted.

6. The television system of claim 4, wherein the angle adjuster extends along the bottom portion of the housing.

7. The television system of claim 4, further comprising an anti-topple portion disposed on the base and connected to the mounting surface by an anti-topple member.

8. The television system of claim 1, wherein the angle adjuster projects from the bottom portion of the housing toward the base and supports the display unit in an inclined state by contacting the base.

9. A pedestal comprising:
a base facing a bottom portion of a display unit which displays an image;
a fixing portion disposed on the base and configured to secure the display unit; and
an angle adjuster projecting from the base and capable of supporting the display unit in an inclined state by contacting the bottom portion of the display unit.

10. An electronic apparatus comprising:
a display unit comprising a display surface which displays an image and a housing which encloses the display surface;
a base placed on a mounting surface such that the base faces a bottom portion of the housing;
a fixing portion disposed on the base and configured to secure the'display unit; and
an angle adjuster disposed on the base and/or the bottom portion of the housing and interposed between the base and the bottom portion so that the display unit is inclined.

11. The electronic apparatus of claim 10, wherein the base, the fixing portion, and the engaging portion are formed integrally with one another.
